(19) United States
(12) Patent Application Publication
(10) Pub. No.: US 2008/0083327 A1
(43) Pub. Date: Apr. 10, 2008

(54) Self-retracting piston with collar

(76) Inventors: Jack Zeljko Saban, Perth (AU); Adrian Notzli, Perth (AU)

Correspondence Address: ADRIAN NOTZLI, 26 McCASKILL WAY, NORANDA, WA, 6062, omitted

(21) Appl. No.: 11/826,056

(22) Filed: Jul. 12, 2007

(30) Foreign Application Priority Data
Oct. 5, 2006 (AU) 2006905479
Nov. 23, 2006 (AU) 2006241329

(51) Int. Cl. F16J 1/00

(52) U.S. Cl. 92/255

(57) ABSTRACT

The present invention consists of a pipe 1 which is open at one end and closed at the other end. There is a collar 2 which is attached to the open end of the pipe 1. The end of the pipe 1 can be closed by using a plug or by other means of manufacture. Within the pipe 1 there is a self-retracting piston consisting of a piston head 3 that rests on a coil compression spring 4 which subsequently rests on the closed end of the pipe 1. There is a perforation 5 at the closed end of the pipe 1.

This application claims priority for a Provisional Patent Application (2006905479) filed Oct. 5, 2006 and a Complete Specification Standard Application (2006241329) filed Nov. 23, 2006 in Australia.

Many gates have a latch system that consists of a sliding bolt that is inserted into a hollow metal pipe to secure the gate and prevent it from opening. The sliding bolt is usually lowered from the gate into the hollow metal pipe, which is buried in the ground. With time the metal pipe can become clogged with small pebbles, sand, dirt, dust and grime, and eventually this latch system becomes difficult or impossible to use. The present invention overcomes this problem by preventing debris from falling into the self retracting piston when it is not in use and by pushing debris out of the pipe after the piston has been compressed, for example by a sliding bolt. The collar assists in keeping the piston clean and prevents to device from being pushed into the ground.

### DETAILED DESCRIPTION OF THE SELF RETRACTING PISTON WITH COLLAR

In the drawings:

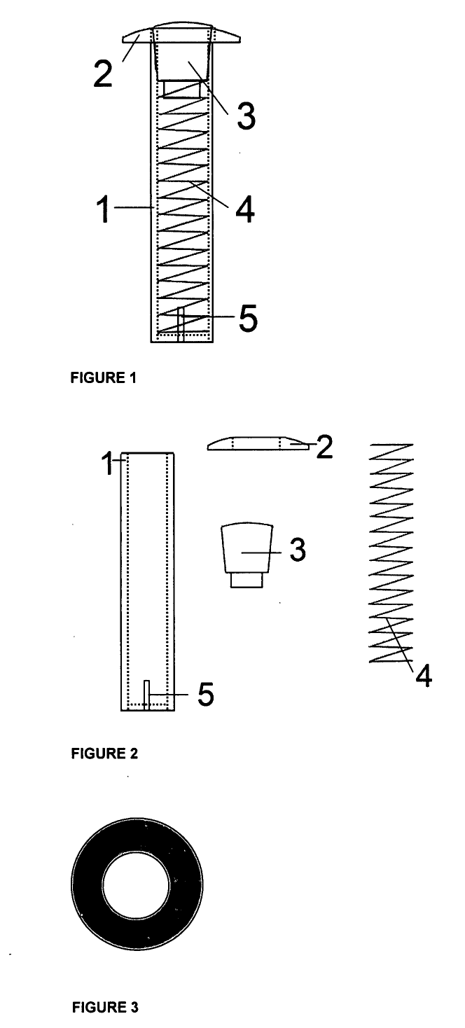

FIG. 1 shows the self retracting piston with collar in its open state.

FIG. 2 shows the components of the self retracting piston.

FIG. 3 shows a top view of the piston. The collar is larger in diameter than the pipe.

Referring to FIG. 2 it can be seen that our self retracting piston consists of

a pipe 1 that is open at one end and closed at the other end with a perforation 5 at the closed end

a collar 2 that is domed

a piston head 3 that is domed

a coil compression spring 4

Referring to FIG. 1 and FIG. 2 the self retracting piston consists of a coil compression spring 4 which rests against the closed end of the pipe 1. There is a collar 2 attached to the open end of the pipe. The collar 2 is wider in diameter than the pipe 1. The collar 2 is domed to assist in keeping debris away from the piston head 3. There are various ways to close one end of the pipe 1 such as, but not limited to, welding a plug or plate onto one open end. The pipe 1 has a perforation 5 at the closed end. A coil compression spring 4 rests inside the pipe 1 and pushes against the closed end of the pipe 1. A piston head 3 rests on top of the spring 4. The piston head 3 has a domed top so that dirt, dust, sand, grit, stones and other debris will slide off the self retracting piston with collar in FIG. 1. The diameter of the bottom of the piston head 3 is less than the diameter of the top of the piston head 3. The outside diameter of the piston head 3 is less than the inside diameter of the pipe 1.

The various components of the self retracting piston should be manufactured from high quality materials such as high grade stainless steel, heavy duty plastics, brass, and/or other materials.

The self retracting piston is installed directly into ground. Only the piston head 3 and collar 2 are visible from the ground. If dirt, dust, sand, pebbles and debris covers the piston head 3 it can be brushed aside. The piston head 3 prevents pebbles, sand, dirt, dust and debris from going into the pipe 1. The collar 2 keeps pebbles, sand, dirt, dust and debris away from the piston head 3. The collar also prevents the invention from being pushed into the ground when the sliding bolt pushes against the piston head.

FIG. 1 demonstrates the self-retracting piston in its open position. The piston head 3 and collar 2 is at ground level and the rest of the self retracting piston is below ground level. The piston becomes compressed when a sliding bolt that is attached to a gate or other device is pushed against the piston head 3. With the sliding bolt firmly secured below ground level the gate is now secured and cannot be opened until the sliding bolt is released. If any pebbles, dirt, grime, dust, sand, rocks and other materials fall between the sliding bolt and the inside wall of the self retracting piston, the material is pushed out by the force of the piston head 3, rendering the invention self-cleaning.

The perforation 5 at the closed end of the pipe 1 allows water to escape from the self retracting piston. Previous devices have not had a perforation 5 and this will cause the piston to seize when too much water gets into them.

The piston head 3 has a wedge shape. The bottom of the piston head 3 is smaller in diameter than the top of the piston head 3. This is critical because fine materials such as sand will occasionally fall between the piston head 3 and the inside wall of the pipe 1. The material will be crushed between the piston head 3 and the wall of the pipe 1 and the wedge shape allows the crushed material to easily fall into the pipe 1. In models where the piston head 3 is parallel with the wall of the pipe 1, fine materials such as sand will seize the device and make the device inoperable.

In other devices an “O” ring is fitted at the top of the piston to create a seal with the piston head 3 and the wall of the pipe 1. We have found that under normal operating conditions the “O” ring rapidly turns to sludge when water and dirt come between the piston head 3 and the inside wall of the pipe 1. This seizes up the self retracting piston and makes it inoperable. We have removed the “O” ring from this invention to prevent this problem from occurring.

The domed shape of the top of the piston head 3 and the collar 2 helps to keep debris away from the piston head 3. Sand or other debris that is strewn across the invention will slide away from the piston head 3. We have found that when the piston head 3 and/or collar 2 are flat fine debris tends to accumulate in the gap between the piston head 3 and the inside wall of the pipe 1. This fine debris has a tendency to fall between the piston head 3 and the inside wall of the pipe 1 and causes the device to seize.

The invention is particularly useful for areas where there is a lot of dirt that can block a pipe, such as gates that use a sliding bolt in farming and industrial areas and animal transportation vehicles and trailers. The invention can be used in currently installed latch systems that have a sliding bolt which is pushed into a pipe. The pipe is replaced with the invention to stop the problem of pebbles, dirt, grime, dust, sand, rocks and other materials clogging up the pipe.

1. The self retracting piston consists of
a pipe that is open at one end and closed at the other end
a collar that is domed on one side
a piston head that is domed on one end
a coil compression spring

2. The self retracting piston of claim 1 should be made of components that are hard, durable, rust-free materials such as, but not limited to stainless steel, rubber or plastic.

3. The self retracting piston of claim 1 has a piston head that has an outside diameter that is smaller than the inside diameter of the pipe.

4. The self retracting piston of claim 1 has a piston head that has a wedge shape with the exposed end of the piston head having a larger diameter than the enclosed end of the piston head.

5. The self retracting piston of claim 1 has a pipe that is open at one end and closed at the other end by, but not limited to, blocking a hollow pipe with a plug or by other means of manufacture.

6. The self retracting piston of claim 1 has a perforation at the closed end of the pipe.

7. The self retracting piston of claim 1 has a collar that is larger in diameter than the pipe and is attached to the open end of the pipe.

8. A self retracting piston can substantially as herein before described with reference to FIGS. 1-3 of the accompanying drawings.
